(19) United States
(12) Patent Application Publication
(10) Pub. No.: US 2026/0167163 A1
(43) Pub. Date: Jun. 18, 2026

(54) VEHICLE CONTROL DEVICE

(71) Applicant: Hitachi Astemo, Ltd., Hitachinaka-shi (JP)

(72) Inventor: Ryosuke SHIMIZU, Hitachinaka-shi (JP)

(73) Assignee: Hitachi Astemo, Ltd., Hitachinaka-shi (JP)

(21) Appl. No.: 19/536,552

(22) Filed: Feb. 11, 2026

Related U.S. Application Data
(63) Continuation of application No. 17/047,146.

(30) Foreign Application Priority Data
Apr. 19, 2018 (JP) 2018-080508

(51) Int. Cl. B60T 8/18; B60T 7/22; B60T 8/171; B60T 8/172; B60T 8/58; B60T 13/66

(52) U.S. Cl. CPC B60T 8/18; B60T 7/22; B60T 8/171; B60T 8/172; B60T 8/58; B60T 13/662; B60T 2201/022; B60T 2210/32; B60T 2220/00; B60T 2250/02

(57) ABSTRACT

Provided is a vehicle control device that can reduce the discomfort to the driver and the influence on an object to be loaded and prevent collision damage. A vehicle control device 100 controls the deceleration of a vehicle 1 based on the distance and the relative speed between the vehicle 1 and an obstacle in front of the vehicle. The vehicle control device 100 includes a control unit 101 that sequentially performs initial braking and main braking on the vehicle 1. The control unit 101 controls a timing of the initial braking based on the estimated weight of the vehicle including the weight of an object to be loaded without changing a timing of the main braking.

### TECHNICAL FIELD

The present invention relates to a vehicle control device, and more particularly, to a vehicle control device mounted on a small- or medium-sized truck or bus to prevent collision damage.

### BACKGROUND ART

In recent years, along with the automation of vehicle control and the cost reduction of sensors, there have been advances in the technology of avoiding or reducing collision damage by detecting obstacles using radars and cameras and automatically applying the brakes when there are possibilities of collision. For example, PTL 1 discloses a vehicle control device mounted on a passenger vehicle. The vehicle control device according to PTL 1 calculates the distance and the relative speed between an obstacle in front of the host vehicle and the host vehicle based on an image captured by a stereo camera, and avoids or reduces collision damage by automatically applying the brake when the calculated distance is too short for the driver to avoid the obstacle.

There have been studies on the application of the above-mentioned vehicle control device used for passenger vehicles to small- and medium-sized trucks or buses (hereinafter referred to as small- or medium-sized trucks or the like). However, the weights of small or medium-sized trucks or the like are smaller than those of passenger vehicles. Accordingly, if control is performed using a hydraulic brake similar to that for passenger vehicles, there is a problem that a sufficient deceleration amount cannot be secured to avoid or reduce collision damage.

In order to solve this problem, for example, as described in PTL 2, there is a technique of using a brake using air pressure (air brake). Thus, by using an air brake instead of a hydraulic brake, it becomes possible to perform sufficient deceleration control.

### CITATION LIST

### Patent Literature

PTL 1: JP 2009-262698 A

PTL 2: JP 2007-320485 A

### SUMMARY OF INVENTION

### Technical Problem

However, the air brake is difficult to handle. When the driver who is usually used to the hydraulic brake operates the brake, a braking force higher than expected is produced, resulting in sudden braking. In addition, when the remaining amount of compressed air runs out, braking will not work, so there is, for example, a problem in that the air meter must be taken into consideration. Further, since equipment such as a compressor and an air tank is required, there is a problem that the device itself becomes large. For this reason, hydraulic brakes are often used in small- or medium-sized trucks or the like.

A hydraulic brake used for a small- or medium-sized truck or the like has a wheel cylinder diameter larger than that of a hydraulic brake used for a passenger vehicle, and the brake pressure increasing speed becomes slow. In addition, since a small or medium-sized truck or the like has a heavier weight than a passenger vehicle, it is difficult to obtain a sufficient deceleration amount. This poses a problem that the braking distance becomes twice or more that of a passenger vehicle.

For this problem, in order to secure a sufficient deceleration amount, it is conceivable to extend the distance that is a condition for the automatic braking to intervene. However, extending the distance will set a braking operation timing earlier than the driver's timing, resulting in discomfort for the driver.

Furthermore, the occurrence of automatic braking may affect an object to be loaded on a small- or medium-sized truck or the like (for example, if the object to be loaded is cargo, the cargo may be damaged, or if the object to be loaded is a passenger, the passenger may fall). Accordingly, the automatic braking device may be invalidated by a switching operation or the like. This may make it impossible to reduce or avoid collision damage.

The present invention has been made to solve such a technical problem, and has an object to provide a vehicle control device that can reduce driver's discomfort and the influence on an object to be loaded and prevent collision damage.

### Solution to Problem

A vehicle control device according to the present invention that can solve the above problem performs deceleration control of a vehicle based on the distance and the relative speed between the vehicle and an obstacle in front of the vehicle. The device includes a control unit configured to sequentially perform initial braking and main braking on the vehicle. The control unit controls the timing of the initial braking based on the estimated weight of the vehicle including the weight of an object to be loaded without changing the timing of the main braking.

### Advantageous Effects of Invention

According to the present invention, it is possible to reduce the discomfort to the driver and the influence on an object to be loaded and prevent collision damage.

### BRIEF DESCRIPTION OF DRAWINGS

FIG. 1 is a block diagram showing the configuration of a vehicle provided with a vehicle control device according to an embodiment.

FIG. 2 is a flowchart showing the control processing performed by the vehicle control device.

FIG. 3 is a flowchart showing the acquisition of the braking operation timing of a driver.

FIG. 4 is a schematic diagram showing an example of a driving scene.

FIG. 5 is a flowchart showing the generation of a braking operation timing table corresponding to relative speeds.

FIG. 6 is a flowchart showing the acquisition of an initial braking maximum deceleration.

FIG. 7 is a flowchart showing the acquisition of an initial braking start inter-vehicle distance.

FIG. 8 is a flowchart showing the acquisition of a controlled deceleration.

FIG. 9: is a flowchart showing the determination of a driver notification.

FIG. 10 is a flowchart showing a modification of the acquisition of an initial braking maximum deceleration.

### DESCRIPTION OF EMBODIMENTS

An embodiment of a vehicle control device according to the present invention will be described below with reference to the accompanying drawings.

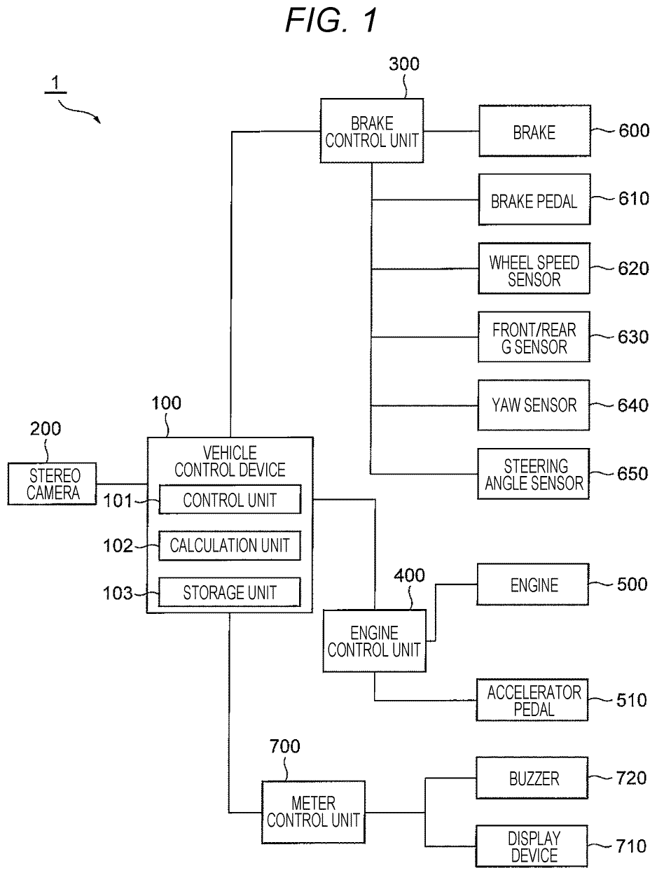

FIG. 1 is a block diagram showing the configuration of a vehicle provided with a vehicle control device according to an embodiment. A vehicle control device 100 according to this embodiment is mounted on a vehicle 1 (hereinafter sometimes referred to as a host vehicle) and performs traveling control including deceleration control of the vehicle 1. A stereo camera 200, a brake control unit 300, an engine control unit 400, and a meter control unit 700 are connected to the vehicle control device 100 by communication (for example, CAN (Car Area Network)).

The vehicle control device 100 is configured as a microcomputer (hereinafter abbreviated as an MC) incorporating a CPU, a ROM, a RAM, and the like, and includes a control unit 101, a calculation unit 102, and a storage unit 103. The control unit 101 implements avoidance or reduction of collision damage by controlling the brake or the like, and sequentially performs initial braking and main braking on the vehicle 1. The calculation unit 102 performs each calculation related to the control of the vehicle 1. The storage unit 103 is composed of a non-volatile memory and stores each information including the braking operation information of the driver.

The vehicle control device 100 stops the operation of the MC when the ignition voltage of the vehicle 1 drops, and restarts the MC to perform each control processing when the ignition voltage of the vehicle 1 becomes equal to or higher than the startup voltage threshold. Therefore, the control processing is not performed in the state in which the ignition voltage is lowered, that is, in the engine stopped state.

The stereo camera 200 is composed of a pair of right and left cameras using solid-state imaging devices such as charge coupled devices (CCDs). The stereo camera 200 is attached near the ceiling of the vehicle compartment, captures images of roads and obstacles in front of the vehicle, and transmits the captured stereo image data to the vehicle control device 100 via CAN.

For example, when the stereo image data of the obstacle imaged by the stereo camera 200 is transmitted to the vehicle control device 100, the calculation unit 102 acquires parallax information from the stereo image, calculates the distance between the host vehicle and the obstacle ahead of the vehicle on the basis of the acquired parallax information, and calculates a relative speed by differentiating the calculated distance with respect to the elapsed time. Further, the calculation unit 102 calculates the lateral position of the imaged obstacle with respect to the host vehicle, and further calculates the lateral speed by differentiating the lateral position with respect to the elapsed time. The vehicle control device 100 performs pattern matching on the image data of the obstacle captured by the stereo camera 200, and classifies the image data into pedestrians, bicycles, vehicles, other stationary obstacles, and the like.

The brake control unit 300 decelerates the vehicle 1 by generating pressure on a brake 600, a brake pedal 610, the disc brake, and the drum brake connected to the brake control unit 300 to generate friction with the wheels. Further, the brake control unit 300 is connected to a wheel speed sensor 620, a front/rear G sensor 630, a yaw rate sensor 640, and a steering angle sensor 650 and measures the host vehicle speed and the like.

The engine control unit 400 is connected to an engine 500 and an accelerator pedal 510 and controls the output of the engine 500. The controlled output transmits power to the wheels of the vehicle 1 through a transmission, a propeller shaft, and the like, thereby accelerating the vehicle 1. Further, the engine control unit 400 not only accelerates the vehicle 1 but also decelerates the vehicle 1 by generating engine braking.

The meter control unit 700 is connected to a display device 710 and a buzzer 720 and gives notifications, warnings, and the like through the visual and auditory senses of the driver.

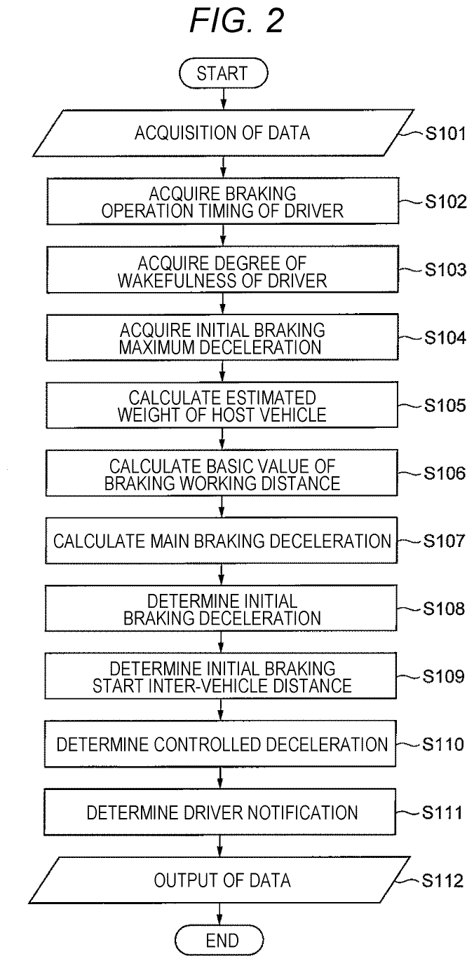

The control processing performed by the vehicle control device 100 will be described next with reference to FIG. 2. The control processing described in the flowchart of FIG. 2 is repeatedly executed at a predetermined cycle (for example, a cycle of 10 ms).

First, in step S101, the vehicle control device 100 acquires data from each of the stereo camera 200, the brake control unit 300, and the engine control unit 400, and converts the data so that the data can be used in the subsequent processing.

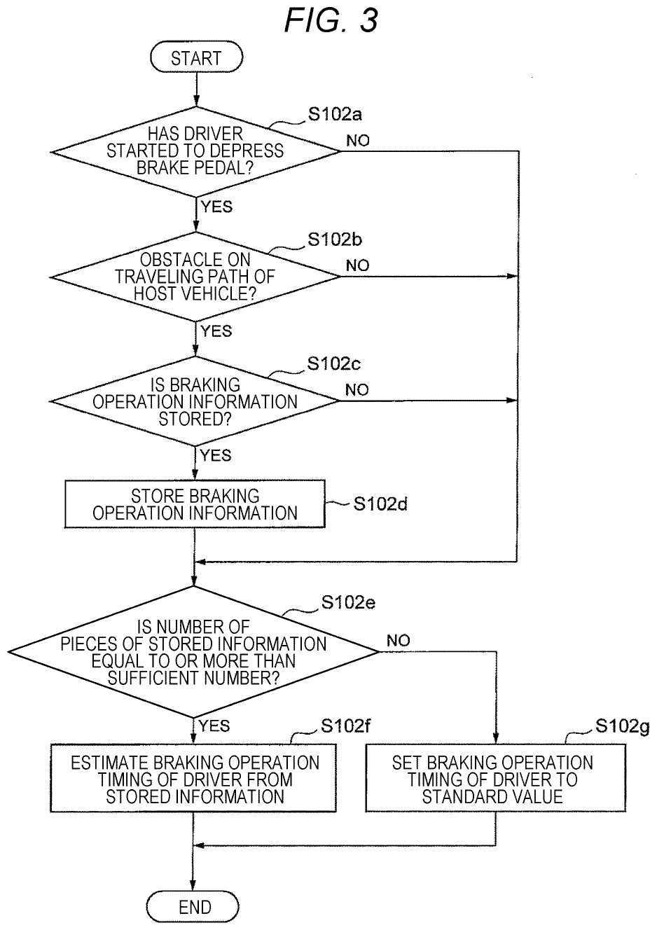

Next, in step S102, the vehicle control device 100 acquires the braking operation timing of the driver. The control processing performed in step S102 is specifically the content shown in the flowchart of FIG. 3.

As shown in FIG. 3, in first step S102a, the vehicle control device 100 determines, based on the information transmitted from the brake control unit 300, whether the driver has started to depress the brake pedal 610, that is, whether the non-depressed state of the brake pedal 610 is converted into the depressed state of the brake pedal 610. If it is determined that the driver has started to depress the brake pedal, the control process advances to S102b. On the other hand, if it is determined that the driver has not started to depress the brake pedal, the control process advances to step S102e.

In step S102a, if the driver has depressed the brake pedal again within 10 sec after it is determined that the driver has started to depress the brake pedal, setting is made not to determine that the driver has started to depress the brake pedal. This setting makes it possible to prevent erroneous determination of the start of brake depression due to a driving operation such as pumping brake or a driving operation such as temporarily reducing braking.

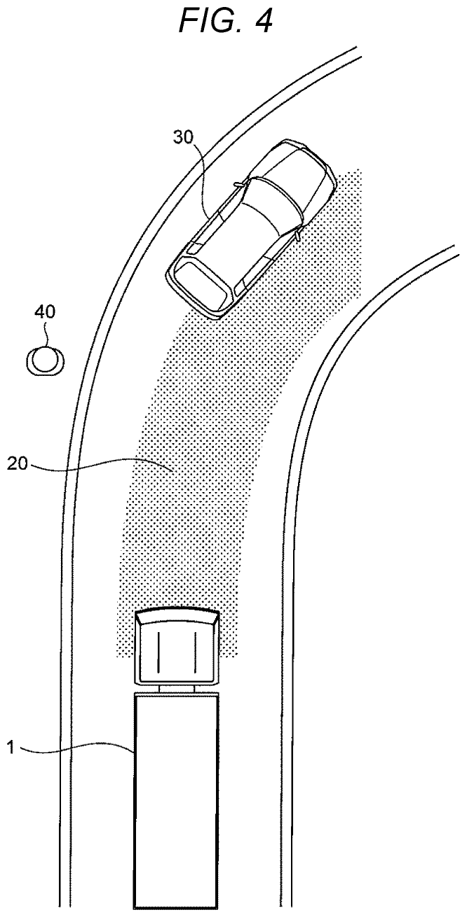

In step S102b, the vehicle control device 100 determines whether there is an obstacle on the traveling path of the host vehicle. Specifically, the vehicle control device 100 acquires the yaw rate detected by the yaw rate sensor 640, the steering angle detected by the steering angle sensor 650, and the host vehicle speed detected by the wheel speed sensor 620. Next, the vehicle control device 100 creates a two-dimensional plane view of the host vehicle as shown in FIG. 4 using the shape of the lane edge lines imaged by the stereo camera 200, and estimates a planned traveling area 20 of the host vehicle on the two-dimensional plane view. Then, the calculation unit 102 calculates distances and lateral positions with respect to obstacles such as a preceding vehicle 30 and a pedestrian 40 based on the data of the respective obstacles imaged by the stereo camera 200. The vehicle control device 100 determines, based on the information calculated by the calculation unit 102, whether the target obstacle exists in the planned traveling area 20.

In the traveling scene shown in FIG. 4, the pedestrian 40 does not exist in the planned traveling area 20, but the preceding vehicle 30 exists in the planned traveling area 20, so that the vehicle control device 100 determines that there is an obstacle on the traveling path of the vehicle. On the other hand, for example, when the preceding vehicle 30 also does not exist in the planned traveling area 20, the vehicle control device 100 determines that there is no obstacle on the traveling path of the host vehicle. If it is determined that there is an obstacle on the traveling path of the host vehicle, the control process advances to step S102c. If it is determined that there is no obstacle on the traveling path of the host vehicle, the control process advances to step S102e.

In step S102c, the vehicle control device 100 determines whether to store the braking operation information of the driver. In this case, it is determined that the braking operation information is stored only when all of the following five conditions are satisfied.

The first condition is that among the obstacles on the traveling path of the host vehicle, the distance between the host vehicle and the nearest obstacle is 10 m or more. Accordingly, for example, even if an obstacle interrupts near the host vehicle, no information about the braking operation for the interruption is stored. That is, information to be stored is limited to information obtained when the brake is applied stably.

The second condition is that a stop line is not imaged by the stereo camera 200 between the host vehicle and the nearest obstacle. This is to make a distinction from braking for the stop line.

The third condition is that the host vehicle should drive at a speed of 20 km/h or more.

Therefore, even if there is no characteristic at low speed, it does not matter, and hence no corresponding information is stored.

The fourth condition is that the driver does not depress the accelerator pedal 510. This is because, if an operation such as the simultaneous depression of the accelerator pedal 510 and the brake pedal 601 is stored, the braking operation timing (to be described later) cannot be correctly estimated, and hence such operation is excluded.

The fifth condition is that a road gradient is estimated based on the value detected by the front/rear G sensor 630 and the host vehicle acceleration obtained from the time derivative of the host vehicle speed, and the estimated upward gradient or downward gradient is 5 deg or more. This is to prevent that the correct braking operation timing cannot be estimated because the braking operation timing can be changed on the gradient road.

If it is determined in step S102c that the braking operation information is stored, the control process advances to step S102d. On the other hand, if it is determined that the information is not stored, the control process advances to step S102e.

In step S102d, the vehicle control device 100 transmits a control signal to storage unit 103 so as to store the following braking operation information. The information stored in the storage unit 103 includes the distance to the closest obstacle among the obstacles on the traveling path of the host vehicle, a relative speed with respect to the closest obstacle, the type of the closest obstacle (for example, pedestrian, vehicle, bicycle, or arbitrary three-dimensional object), a host vehicle speed, a road gradient, a road curvature, the estimated weight of the host vehicle, the illuminance (e.g. night or day) detected by the stereo camera, and the weather (e.g. rain, snow, or fair) detected by the stereo camera. In this case when the weather is fair, it means that the traveling road is a dry road.

The storage unit 103 has a storage area for a sufficient number of times of braking operations to estimate the braking operation timing of the driver, for example, an area for storing data for 250 times of braking operations, and stores the information in a FIFO (first in, first out) system. The storage unit 103 is composed of a nonvolatile memory as described above, and is initialized to have no stored information at the time of manufacturing the vehicle 1. Even when the ignition of the vehicle 1 is turned off, the braking operation information stored after the manufacturing is kept stored. This makes it possible to prepare the stored brake information immediately after the engine starts. Further, it is preferable that the storage unit 103 holds the stored braking operation information even after the power of the vehicle 1 is stopped and does not store any braking operation information when the power of the vehicle 1 is stopped.

In step S102e, the vehicle control device 100 determines whether the number of pieces of driver's braking operation information stored in the storage unit 103 is a sufficient number or more. The sufficient number of times here is enough to estimate the braking operation timing of the driver, for example, 50 times or more. If it is determined that the number of times is sufficient or more, the control process advances to step S102f. If it is determined that the number of times is not sufficient or more, the control process advances to step S102g.

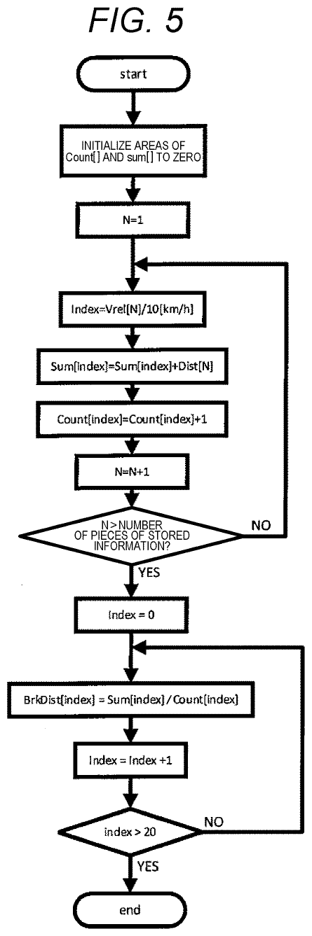

In step S102f, the control unit 101 estimates the braking operation timing of the driver based on the braking operation information stored in the storage unit 103. The braking operation timing of the driver is estimated as a table value corresponding to a relative speed. A table value is estimated according to the flowchart of FIG. 5.

More specifically, braking operation timing estimation information is classified for each relative speed of 10 km/h, and the average of the distances when the braking operation is performed in each relative speed range is calculated to estimate the braking operation timing of the driver. The control unit 101 then sets a timing later than the estimated braking operation timing as the initial braking timing. Referring to FIG. 5, the braking operation timing of the driver is indicated by “BrkDist”.

In step S102g, the control unit 101 sets the braking operation timing of the driver to a standard value. The standard value corresponds to the “predetermined braking operation timing” described in the scope of claims, and is, for example, the relative speed between the host vehicle and an obstacle×5 sec.

Next, in step S103 of the flowchart shown in FIG. 2, the vehicle control device 100 acquires the degree of wakefulness of the driver. The degree of wakefulness of the driver serves as a parameter for estimation as an index for determining how much the driver can concentrate on driving, or whether the driver is not falling asleep at the wheel. The control unit 101 estimates the degree of wakefulness of the driver by detecting the following driving operations of the driver.

That is, the driving operations include driving the host vehicle with its direction being periodically inclined to the right and left with respect to the white line detected by the stereo camera 200, driving the host vehicle with a little change in the amount of depression of the accelerator pedal, driving the host vehicle without shift change for a predetermined period of time, driving the host vehicle with the vibration of the steering angle being detected, driving the host vehicle with weak steering torque, and driving the host vehicle with a high frequency of sudden braking.

In addition, the driver's degree of wakefulness is set to a parameter that decreases according to the number of detected driving operations of the driver. The amount of change and the threshold of time are set according to the vehicle, and weights are set for each condition and reflected in the degree of wakefulness.

For example, the condition to be set when the steer torque is low is that the weight is 3, and the degree of wakefulness is −3 when the steer torque is low. The condition that a predetermined amount of time has elapsed without any shift change is that a weight of 1 is set, and when a predetermined amount of time has elapsed without any shift change, the degree of wakefulness is set to −1. By weighting according to the conditions in this way, it is possible to determine the parameter as being closer to the degree of wakefulness of the driver.

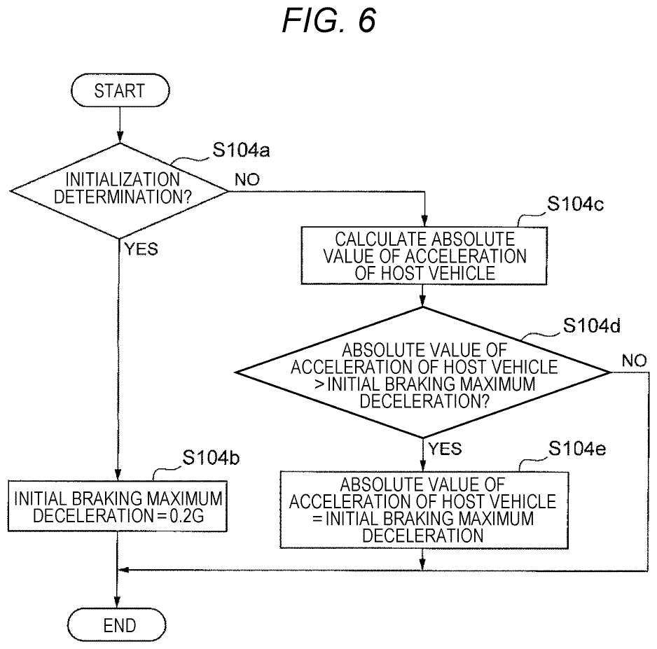

In step S104, the vehicle control device 100 acquires the initial braking maximum deceleration. For example, the flowchart of FIG. 6 shows the details of the control processing performed in step S104.

As shown in FIG. 6, in first step S104a, the vehicle control device 100 performs initialization determination. The initialization determination is performed based on whether one of the following conditions is satisfied. That is, the conditions include that the host vehicle speed has not reached 0 within 2 sec after the detection of the release of the seat belt, that the host vehicle speed has not reached 0 within 2 sec after the detection of the opening of the door switch including the rear gate, that a predetermined stoppage time has elapsed without detection of any preceding vehicle and any traffic light while the brake pedal is not depressed, and that the weight of an object to be loaded increases by 10 kg or more in 5 sec. Examples of the stoppage in the situation where the preceding vehicle and the traffic signal are not detected and the brake pedal is not depressed include stoppage in the neutral range and the parking brake.

If the initialization determination is established, the control process advances to step S104b. In step S104b, the control unit 101 sets the initial braking maximum deceleration to 0.2 G.

If the initialization determination is not established, the control process advances to step S104c. In step S104c, the calculation unit 102 calculates the current absolute acceleration value of the host vehicle. In step S104d subsequent to step S104c, the vehicle control device 100 compares the current absolute acceleration value of the host vehicle with the initial braking maximum deceleration in the previous cycle. When the initial braking maximum deceleration in the previous cycle is smaller than the current acceleration absolute value of the host vehicle, the control unit 101 sets the current absolute acceleration value of the host vehicle as the initial braking maximum deceleration in this cycle (step S104e).

At this time, if the driver is accelerating by 0.2 G or more in a driving operation, it can be determined that there is no problem even if a shock of 0.2 G or more is given to an object to be loaded. This makes it possible to increase the maximum deceleration faster than performing determination only by the acceleration generated by deceleration. In addition, if the acceleration detected by the wheel speed differential of the host vehicle deviates from the braking force of the host vehicle or the acceleration estimated from the output of the power unit, the weight of the object to be loaded used for the condition can be estimated by calculating the ratio between the accelerations. Note that, in this case, a sensor for detecting the weight of an object to be loaded may be separately provided.

In acquiring the initial braking maximum deceleration, in addition to the contents described above, in consideration of, for example, a change in the weight of the object to be loaded, when the change in the weight of the object to be loaded falls within a predetermined range, the control unit 101 may set maximum the the value of acceleration/deceleration absolute value generated at the time of driving of the vehicle as the initial braking maximum deceleration.

In step S105 of the flowchart shown in FIG. 2, the calculation unit 102 calculates the estimated weight of the host vehicle. The estimated weight of the host vehicle is the total value of the weight of the vehicle and the weight of the object to be loaded. The object to be loaded refers to luggage or a passenger. The estimated weight of the host vehicle is obtained based on the engine torque, the reduction ratio of the transmission, the estimated value of running resistance, the dynamic tire radius, and the acceleration of the host vehicle. For example, the estimated weight of the host vehicle is calculated by Equation (1).

$$estimated weight of the host vehicle = engine torque \times reduction ratio / acceleration / dynamic tire radius \qquad ( 1 )$$

The estimated value of the running resistance can be calculated from the sum of the air rolling resistance obtained from the host vehicle speed, the vehicle shape (air resistance characteristics), and the tire width, the gradient resistance obtained from the road gradient, and the cornering resistance obtained from the generation of a lateral acceleration.

In step S106, the calculation unit 102 calculates the basic value of the control working distance. The calculation of the basic value of the control working distance is performed based on the table values prepared in advance from relative speeds. A table value is set with reference to a relative speed×TTC (Time To Collision) as a basic value, and is corrected by increasing the distance when the relative speed is large. Since the basic value of the control working distance includes the basic value of the initial braking working distance and the basic value of the main braking working distance, the basic value of the initial braking working distance and the basic value of the main braking working distance are calculated respectively.

In step S107, the calculation unit 102 calculates the main braking deceleration amount. The main braking deceleration amount is calculated based on Equation (2) from the estimated weight of the host vehicle calculated in step S105.

$$vehicle acceleration [ m / ss ] = braking force [ N ] / estimated weight of host vehicle [ kg ] \qquad ( 2 )$$

$$main braking deceleration amount [ m / s ] = vehicle acceleration [ m / ss ] \times time [ s ]$$

Since the braking force according to Equation (2) is determined by the braking performance of the vehicle 1, a constant is set as a control parameter for the vehicle equipped with the vehicle control device. Further, the time is set as a control parameter for the vehicle equipped with the vehicle control device with the time until collision avoidance being set as a threshold.

In step S108, the vehicle control device 100 determines the initial braking deceleration. The vehicle control device 100 compares the initial braking maximum deceleration obtained in step S104 with the initial braking deceleration lower limit, selects one that corresponds to a stronger deceleration, and determines it as the initial braking deceleration.

The initial braking deceleration lower limit here is a deceleration that is strong enough to allow the driver to perceive the occurrence of deceleration and is set to a constant, for example, 0.2 G, as a deceleration that does not affect an object to be loaded (for example, does not damage cargo or cause a passenger to fall).

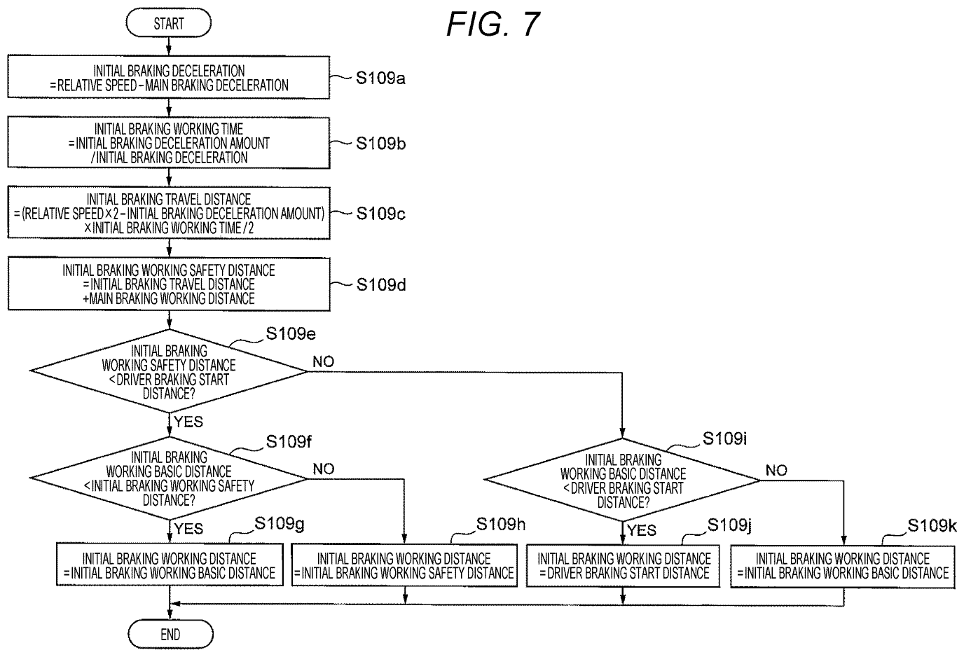

In step S109, the vehicle control device 100 determines an initial braking start inter-vehicle distance. For example, the flowchart of FIG. 7 shows the details of the control processing performed in step S109.

As shown in FIG. 7, in first step S109a, the calculation unit 102 gives the current relative speed to the braking operation timing information, which is table value information corresponding to the relative speed calculated in step S102 to calculate a driver braking start distance corresponding to the driver's braking operation timing. Subsequently, the calculation unit 102 calculates an initial braking deceleration amount by subtracting a main braking deceleration amount from a relative speed.

In step S109b, the calculation unit 102 calculates an initial braking working time by dividing the initial braking deceleration amount by the initial braking deceleration.

In step S109c, the calculation unit 102 calculates an initial braking travel distance by dividing the product of the value obtained by subtracting the initial braking deceleration amount from twice the relative speed and the initial braking working time by 2.

In step S109d, the calculation unit 102 adds the initial braking travel distance and the main braking working distance to calculate an initial braking working safety distance as a distance that allows collision avoidance when a brake is applied.

In step S109e, the vehicle control device 100 compares the initial braking working safety distance with the driver braking start distance. If it is determined that the initial braking working safety distance is smaller than the driver braking start distance, the control process advances to step S109f to compare the initial braking working basic distance with the initial braking working safety distance. If the initial braking working basic distance is smaller than the initial braking working safety distance, the control unit 101 sets the initial braking working distance as the initial braking working basic distance (step S109g). On the other hand, if the initial braking operation basic distance is equal to or more than the initial braking operation safety distance, the control unit 101 sets the initial braking working distance as the initial braking operation safety distance (step S109h).

If it is determined in step S109e that the initial braking operation safety distance is equal to or more than the driver braking start distance, the control process advances to step S109i to compare the initial braking working basic distance with the driver braking start distance. If the initial braking working basic distance is smaller than the driver braking start distance, the control unit 101 sets the initial braking working distance as the driver braking start distance (step S109j). On the other hand, if the initial braking working basic distance is equal to or more than the driver braking start distance, the control unit 101 sets the initial braking working distance as the initial braking working basic distance (step S109k).

Since the initial braking working safety distance and the driver braking start distance are compared in step S109e described above, initial braking is performed earlier than the driver's usual braking operation, so that the start of the initial braking can be a timing that gives less discomfort to the driver. In addition, by comparing with the basic value of the initial braking working distance in step S109e or step S109i, even in the case of a driver whose brake timing is too late compared to a general driver, minimum warning and damage reduction braking operation can be performed.

The vehicle control device 100 then determines the initial braking working distance obtained by the flowchart of FIG. 7 as the initial braking start inter-vehicle distance (that is, the initial braking working timing).

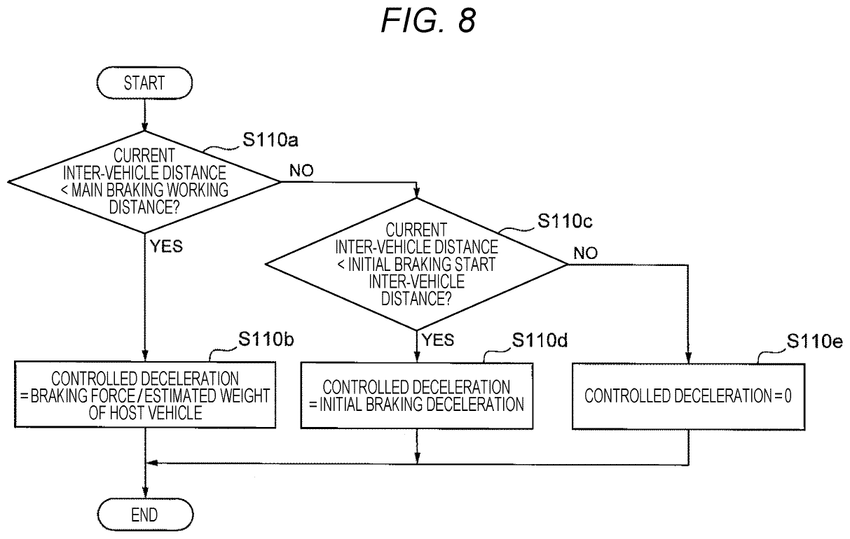

In step S110 of the flowchart shown in FIG. 2, the vehicle control device 100 determines a controlled deceleration. The flowchart of FIG. 8 shows the details of the control processing performed in step S110.

As shown in FIG. 8, in first step S110a, the vehicle control device 100 compares the current inter-vehicle distance with the main braking working distance. When the current inter-vehicle distance is smaller than the main braking working distance, the vehicle control device 100 determines that the main braking is caused to work, and determines a controlled deceleration by dividing the braking force by the estimated weight of the host vehicle, thus performing control with the maximum deceleration generated for the vehicle (step S110b).

If the current inter-vehicle distance is equal to or more than the main braking working distance in step S110a, the control process advances to step S110c to compare the current inter-vehicle distance with the initial braking start inter-vehicle distance. If the current inter-vehicle distance is smaller than the initial braking start inter-vehicle distance, the vehicle control device 100 sets a controlled deceleration to the initial braking deceleration, thereby performing brake control with a deceleration amount that does not damage the object to be loaded (step S110d).

If the current inter-vehicle distance is equal to or more than the initial braking start inter-vehicle distance, the vehicle control device 100 does not need deceleration control and sets the controlled deceleration to zero, thereby not performing control (step S110e).

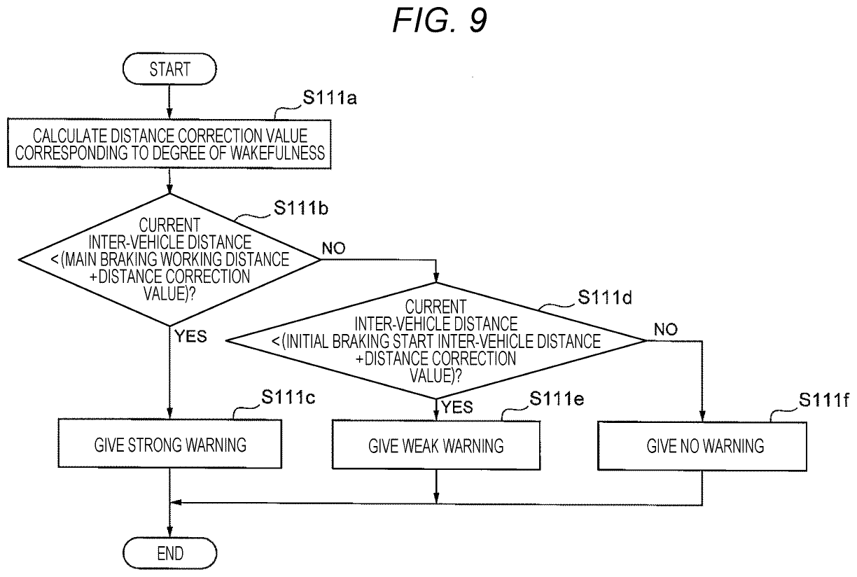

In step S111 of the flowchart shown in FIG. 2, the vehicle control device 100 determines a driver notification operation. For example, the flowchart of FIG. 9 shows the details of the control processing performed in step S111.

As shown in FIG. 9, in first step S111a, the calculation unit 102 calculates a distance correction value corresponding to the degree of wakefulness. In step S111b, the vehicle control device 100 compares the current inter-vehicle distance with the sum of the main braking working distance and the distance correction value. When the current inter-vehicle distance is smaller than the sum of the main braking working distance and the distance correction value, the vehicle control device 100 indicates a strong warning degree to the driver with a large alarm sound, strong blinking, and the like (step S111c). The driver then can recognize a warning or the like via the display device 710 and the buzzer 720.

If the current inter-vehicle distance is equal to or more than the sum of the main braking working distance and the distance correction value in step S111b, the control process advances to step S111d to compare the current inter-vehicle distance with the sum of the initial braking start inter-vehicle distance and the distance correction value. If the current inter-vehicle distance is smaller than the sum of the initial braking start inter-vehicle distance and the distance correction value, the vehicle control device 100 indicates a weak warning degree to the driver with a weaker alarm sound or weaker blinking than in step S111c (step S111e). Selectively using the magnitudes of the warning degree in this way can more clearly inform the driver of the degree of danger.

If the current inter-vehicle distance is equal to or more than the sum of the initial braking start inter-vehicle distance and the distance correction value, the vehicle control device 100 does not warn the driver (step S111f).

Performing this process can promote the avoidance behavior of the driver by issuing a warning to the driver earlier than usual in a situation where the degree of wakefulness is low, that is, in a situation where the driver is dozing and driving or looking away. However, by not performing deceleration control at this time, the problem of damaging the object to be loaded or the problem of disturbing the traffic flow and causing a collision accident can be prevented by accelerating the start of control, thereby reducing risks leading to accidents.

In step S112 of the flowchart shown in FIG. 2, the vehicle control device 100 outputs data based on the result processed in step S111. The vehicle control device 100 also transmits a control signal to the brake control unit 300 and the meter control unit 700 to execute deceleration by the brake, warning to the driver, and the like.

According to the vehicle control device 100 of the present embodiment, the control unit 101 controls the timing of initial braking based on the estimated weight of the vehicle (including the weight of an object to be loaded) without changing the timing of main braking. This can reduce the discomfort to the driver and the influence on the object to be loaded and prevent collision damage. Moreover, by not changing the timing of the main braking in this way, it is possible to prevent a malfunction caused by, for example, accelerating the main braking and to prevent damage to an object to be loaded due to the malfunction. This embodiment has exemplified the case in which the calculation unit 102 calculates the estimated weight of the vehicle (including the weight of an object to be loaded). If, however, the calculation unit 102 is not provided, the control unit 101 may calculate the estimated weight of the vehicle.

Various modifications of the vehicle control device 100 of the present embodiment can be considered.

### <Modification 1>

For example, the braking operation timing and the like differ depending on the driver. Assume that one vehicle is shared by a large number of people. In step S102 described above, the storage unit 103 is preferably provided with an area for storing braking operation information for each driver to store a braking operation timing suitable for the characteristics of each driver. In this case, as a driver identification method, for example, a unique vehicle key is assigned to each driver, and the vehicle control device 100 identifies the driver with the key and grasps a driver change. That is, in this case, the vehicle control device 100 functions as a driver identification unit that identifies the driver. In addition to the key, information such as an IC card and fingerprint authentication that can identify the driver individually is registered in advance, and the vehicle control device 100 identifies the driver with the IC card and fingerprint authentication and acquires the braking operation timing information and the like of each driver from the storage unit 103.

In addition, when one vehicle is shared by a large number of people, there may be a problem that the capacity of the storage unit 103 becomes huge. In this case, it is possible to store or acquire braking operation timing information of a large number of people by reading driver information registered in the center server in advance via a portable terminal including a cell phone or communication. Furthermore, when the braking operation timing information of each driver is stored or read using the portable terminal or the center server as described above, there is an advantage that the information can be shared by a plurality of vehicles.

### <Modification 2>

It is assumed that the vehicle to which the present invention is applied is a small- or medium-sized bus and objects to be loaded are unspecified passengers. In this case, there is no risk of damage as compared with a case where objects to be loaded are works of art, precision equipment, and the like, and hence step S104 can be replaced with the contents described below.

That is, when an in-vehicle monitoring camera is provided and the in-vehicle monitoring camera detects that there is no passenger in the vehicle, the initial braking maximum deceleration is set to the maximum allowable deceleration, for example, 0.4 G. On the other hand, when the camera detects that a passenger is present and there is a standing passenger, the initial braking maximum deceleration is set to a deceleration that prevents the passenger from falling, for example, 0.15 G. Further, when there are passengers and no standing passengers, the initial braking maximum deceleration is set to a deceleration that does not cause a passenger sitting on the seat to fall without a seat belt, for example, 0.3 G.

This makes it possible to prevent passengers from being injured by falling down due to the occurrence of sudden braking and to reduce the damage caused by collision accident. In this case, the method using the in-vehicle monitoring camera can be replaced by a method of determining a position in the vehicle at which a passenger is present by using a pressure sensor or radar or a method of performing determination by using an interface provided to allow the driver to monitor the in-vehicle situation and notify the situation.

Furthermore, as in the case of expressway buses, when passengers sit on seats and use seat belts, there is less risk of injury due to falling down, so the initial braking maximum deceleration is set to the maximum deceleration allowed, for example 0.4 G.

### <Modification 3>

Further, when an object to be loaded is a package managed by a barcode or the like (also referred to as a transport object) as in a delivery business, step S104 described above can be changed to the following contents.

The vehicle control device 100 obtains information about luggage to be loaded in the host vehicle by communicating with the center of the delivery system. Upon grasping information indicating that the contents of luggage are items that are likely to be damaged due to the generation of acceleration, such as precision equipment and works of art, the vehicle control device 100 sets the initial braking maximum deceleration to a deceleration that does not cause damage, for example, 0.2 G. In contrast, upon grasping information indicating that the luggage is a shock-resistant transport object such as clothes, the vehicle control device 100 sets the initial braking maximum deceleration to a maximum allowable deceleration, for example, 0.4 G. In this case, the vehicle control device 100 changes the initial braking maximum deceleration according to the contents of the luggage.

There is also a method in which the contents of luggage are grasped in the center of the delivery system, and the vehicle control device acquires the result by communication. Further, there is also a method of grasping the contents of luggage, not in the center of the delivery system, but by the driver directly selecting the type of luggage and performing an input operation using a switch or the like, or directly referring to the barcode of the luggage.

### <Modification 4>

The initialization determination condition in step S104 can be replaced with any of the following conditions. For example, the conditions include when the value detected by the pressure-sensitive sensor of the loading platform changes while the vehicle is stopped, or when a moving body is detected by a sensor such as a camera or radar that monitors the loading platform while the vehicle is stopped. This increases the cost of adding a sensor such as a camera but can reliably check the loading and unloading of luggage.

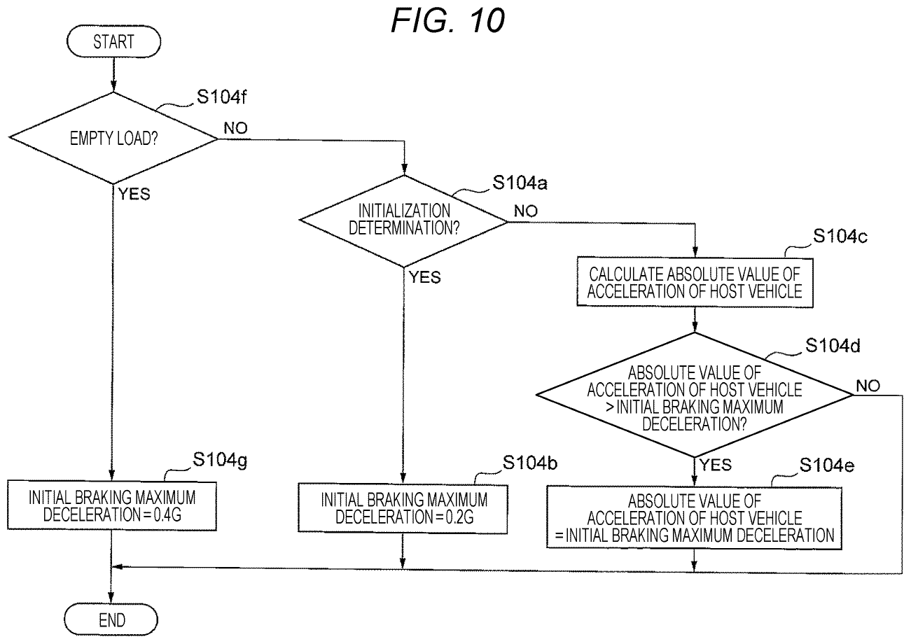

For example, when the loading/unloading of luggage is checked by using a pressure-sensitive sensor, a camera, or the like, it is possible to easily determine the presence/absence or change of an object to be loaded. In this case, the processing in step S104 shown in FIG. 6 can be changed to the flowchart shown in FIG. 10. More specifically, as can be seen by comparing FIG. 6 and FIG. 10, before the initialization determination (step S104a), processing (step S104f) of determining whether the vehicle is in an empty load state is added.

If it is determined in step S104f that the vehicle is in an empty load state, the vehicle control device 100 sets the initial braking maximum deceleration to the maximum allowable deceleration, example, for 0.4 G without performing initialization determination (step S104g). This makes it possible to immediately determine that there is no risk of damage to an object to be loaded and maximize the amount of reduction in collision damage. In contrast, if it is determined that the vehicle is not in an empty load state, the control process may advance to step S104a to perform the above initialization determination.

### <Modification 5>

When the degree of wakefulness of the driver in step S103 described above is updated, the vehicle control device 100 stores the updated data in the storage unit 103 and holds the information of the degree of wakefulness of the driver even after the engine is stopped. The stored value of the degree of wakefulness can be taken over when the engine is turned on next.

This makes it possible to correctly determine the degree of wakefulness and give an appropriate warning even when the driver is unlikely to recover and return to the awake state in a short time upon turning off the engine.

In addition, when the degree of wakefulness of the driver is stored, the date and time are stored at the same time. This makes it possible to reset the stored degree of wakefulness to prevent excessive warning in a case where the time (for example, 3 hr or more) required for the driver to recover has elapsed since the stored date and time when the engine is turned on, as well as in case where the current driver is identified by a method like that described in Modification 1 and the change of the driver is detected.

Although the embodiments of the present invention have been described above in detail, the present invention is not limited to the above-described embodiments, and various changes in design can be made without departing from the spirit of the present invention described in the appended claims.

### REFERENCE SIGNS LIST

1 vehicle
100 vehicle control device
101 control unit
102 calculation unit
103 storage unit
200 stereo camera
300 brake control unit
400 engine control unit
500 engine
510 accelerator pedal
600 brake
610 brake pedal
620 wheel speed sensor
630 front/rear G sensor
640 yaw rate sensor
650 steering angle sensor
700 meter control unit
710 display device
720 buzzer

1-8. (canceled)

9. A vehicle control device that performs deceleration control of a vehicle based on a distance and a relative speed between the vehicle and an obstacle in front of the vehicle, the device comprising:
a control unit configured to sequentially perform initial braking and main braking on the vehicle;
a calculation unit configured to calculate a current absolute value of acceleration of the vehicle and an estimated weight of the vehicle, the estimated weight including a weight of an object to be loaded; and
a storage unit configured to store information on a driving operation by a driver of the vehicle,
wherein
the control unit controls timing of the initial braking without changing timing of the main braking, and
in acquiring an initial braking maximum deceleration of the initial braking, in a case where initialization determination repeatedly executed by the vehicle control device at a predetermined cycle is not established, a maximum value of an absolute value of acceleration generated through the driving operation of the vehicle by the driver of the vehicle from a time when the initialization determination is not established up to a current time is set as the initial braking maximum deceleration.

10. The vehicle control device according to claim 9, wherein when a change in the weight of the object to be loaded falls within a predetermined range, the control unit sets a maximum value of an absolute value of acceleration/deceleration generated through the driving operation of the vehicle by the driver of the vehicle from the time when the initialization determination is not established up to the current time as the initial braking maximum deceleration.

11. The vehicle control device according to claim 9, wherein in a case where the initialization determination executed by the vehicle control device is established, the control unit sets the initial braking maximum deceleration to 0.2 G.

12. The vehicle control device according to claim 9, wherein the control unit estimates a degree of wakefulness of a driver based on a driving operation of the driver, and controls the initial braking timing in accordance with the estimated degree of wakefulness.

13. The vehicle control device according to claim 9, further comprising a storage unit configured to store braking operation information of the driver,
wherein when the number of braking operations of the driver stored in the storage unit is not less than a predetermined number, the control unit estimates a braking operation timing of the driver based on the braking operation information of the driver stored in the storage unit, and sets a timing that is later than the estimated braking operation timing as the initial braking timing.

14. The vehicle control device according to claim 9, further comprising a storage unit configured to store braking operation information of the driver,
wherein when the number of braking operations of the driver stored in the storage unit is less than a predetermined number, the control unit sets a predetermined braking operation timing as the initial braking timing.

15. The vehicle control device according to claim 13, further comprising a driver identifying unit configured to identify a driver who drives the vehicle,
wherein the storage unit has an area for storing driver's braking operation information for each driver.

16. The vehicle control device according to claim 15, wherein the storage unit holds the braking operation information even after power of the vehicle is stopped and does not store the braking operation information when the power of the vehicle is stopped.
